(19) United States
(12) Patent Application Publication
(10) Pub. No.: US 2014/0268240 A1
(43) Pub. Date: Sep. 18, 2014

(54) System And Method For The Accelerated Screening Of Digital Images

(71) Applicant: Rampage Systems Inc., Waltham, MA (US)

(72) Inventors: Mitchell BOGART, Sharon, MA (US); Vasile DOMAN, Andover, MA (US); Patrick FLAHERTY, Norwood, MA (US)

(73) Assignee: Rampage Systems Inc., Waltham, MA (US)

(21) Appl. No.: 14/209,180

(22) Filed: Mar. 13, 2014

Related U.S. Application Data
(60) Provisional application No. 61/779,762, filed on Mar. 13, 2013.

(51) Int. Cl. H04N 1/52

(52) U.S. Cl. CPC H04N 1/52
USPC 358/3.2

(57) ABSTRACT

Writing unscreened raster image data into a computing device that contains multiple elements capable of screening raster image data, and executing a plurality of processes within the multiple elements, wherein segments of the unscreened raster image data are simultaneously screened by the plurality of processes. The computing device could utilize graphical processing units, field programmable gate arrays, application specific integrated circuits or other processing devices.

### RELATED APPLICATIONS

This application claims priority to U.S. Provisional Application No. 61/779,762 filed on Mar. 13, 2013 which is incorporated herein by reference.

### BACKGROUND

General purpose Graphical Processing Units (GPUs) are an evolutionary development of the high powered multiple processor video cards used for faster smoother graphics by the video gaming market. GPUs contain thousands of processing cores, are programmed in ways related to conventional CPUs, and do not require or even have video output capability. They are in increasing use in worldwide world-class institutions such as NASA and CERN, because they offer tremendous parallel processing power at a greatly reduced cost compared to CPUs.

Screening for printing is the process of computing, from a continuous tone image, a large array of on/off values or, for multiple gray-level printers, an array of gray-level values, whose visual effect after printing is as close as possible to the continuous tone image provided as input.

For example, a continuous tone image may have each of its pixels defined as a combination of four colors: cyan, magenta, yellow, and black, and the intensity of each color may be specified by a value in the range of 0 to 1023. Printers, however, are not capable of producing a dot of ink with 1024 levels of intensity. Most printers are only capable of turning a dot of ink on or off, though some printers can produce dots of a few different intensities by varying the amount of ink in each droplet. Typically, these printers can produce only a few different intensity levels using, for example, a small, medium, or large dot of ink, or no ink, to print pixels of four intensities.

Screening is the process of determining which dots of each color of printed ink should be turned on or off to reproduce, as closely as possible, the original continuous tone image. For printers that can produce dots of different intensities, screening would include determining the intensity of each dot rather than only whether the dot should be turned on or off.

Using a conventional approach, if an image is to be printed all the steps of FIG. 1 must be employed. The process begins with an input file that describes the printed material. The file may include mathematical descriptions, for example the diameter of a circle, and the file may include literal descriptions, for example specifying the color of each pixel of a photograph. The mathematical and literal descriptions are interpreted, and the image is rendered, meaning that the color and intensity of each pixel of the continuous tone output image is described. Screening is then performed, and the screened raster, row by row, column by column data, is sent to a printer or other imaging device. If at a later time the image is to be reprinted, for example to change the screening, when using a conventional approach all the steps of FIG. 1 must again be employed. This is a disadvantage that makes the conventional approach useless for meeting the requirements of many printing devices, particularly those currently under development such as the next generation of digital printing presses.

Using conventional printing presses, many copies of an image, typically many thousands, would be printed. As a printing run progresses, a press operator would monitor the printed output, and as the press characteristics change, perhaps because the press warms up, the appearance of the printing would change. The press operator would manually adjust the press to keep the appearance of the printed material consistent, and the consistency would depend on the skill of the press operator.

It is certainly a goal for future generations of printing presses to automatically monitor the printed output and, in addition to measuring overall changes in color, to monitor specific features such as a clogged nozzle that would leave a streak on the printed material or a localized area where color changes. If the time to produce new screened data for the press—which could include alternate nozzle selection data, correcting overall color change, and correcting localized color change—were less than the time to print a page, automated on-the-fly correction could be applied without stopping the press.

On-the-fly correction would not be possible using a conventional approach, for the time to interpret and render an image is long compared to the time to print the image. The conventional approach to screening is also long compared to the time to print a page.

### SUMMARY OF THE INVENTION

The system and method for the accelerated screening of digital images utilizes multiple computing devices such as cores in a GPU to screen the pixels of a continuous tone image to produce screened output data. The multiple cores simultaneously screen multiple continuous tone input lines or, if there are enough cores, multiple segments of multiple input lines, to produce multiple output lines or multiple segments of multiple output lines.

Screening occurs by processing each line of continuous tone input pixels to create a line of screened output pixels. In most forms of screening, the screening of each continuous tone line, to create a screened line, is independent of the data in any other continuous tone input line or screened output line. Because the screening of a line is independent of the data in other lines, screening of multiple lines can be implemented by parallel processing. That is, many lines can be screened simultaneously if there are multiple processors available to do the work.

The system and method of the present invention is not limited to screening by multiple cores of a GPU. The GPU, with its thousands of processor cores, is ideal for the parallel processing required. The invention could be implemented in other devices that contain multiple duplicate computing units and memory, such as multiple hardware units in a field programmable gate array (FPGA) or an application specific integrated circuit (ASIC). These devices are also capable of parallel processing and screening.

In an imaging process that uses the system and method of the present invention, the input file is interpreted and rendered, as in the conventional approach, but instead of the results being screened and sent to a printer, the results are stored in an unscreened format. Storage of the interpreted and rendered image in unscreened format is key to the invention.

In the system and method of the present invention, because interpreted, rendered, unscreened data is saved, then to correct a page on-the-fly, no interpretation and rendering is necessary. Only rescreening is necessary. And, since screening with a GPU or other parallel computing device is faster than the time to print a page, printing with device corrections can be done on-the-fly.

It is the combination of the saving of interpreted, rendered, unscreened data; and the use of a GPU or other parallel computing device to do the screening; that makes keeping up with the on-the-fly changes required by fast printing devices possible.

### BRIEF DESCRIPTION OF THE DRAWINGS

FIG. 1 is a schematic diagram of the conventional approach used for printing.

FIG. 2 is a schematic diagram of the components of the system of the present invention.

FIG. 3a is a schematic view of a card containing two GPUs that plugs into a slot in a host computer.

FIG. 3b is a schematic view of the system of the present invention that utilizes the cards shown in FIG. 3a.

FIG. 4 is a representation of a four color image being processed by eight GPUs.

FIG. 5 is a representation of the elements of input data required for screening.

FIG. 6 is a flow chart of the method of screening digital data of the present invention.

FIG. 7 is a flow chart that shows the control of a GPU in the method shown in FIG. 6 by software in the host computer.

FIG. 8 is a flow chart of the operation of GPU cores performing screening in the method shown in FIG. 6.

### DETAILED DESCRIPTION OF THE INVENTION

Referring to FIG. 1, in preparation for printing in a conventional printing system, a page is processed by a Raster Image Processor (Rip) 14, which converts the input file 12, usually a PostScript or Pdf file, into the low level screened information to control each individual dot of a printing or other imaging device 16.

FIG. 1 illustrates this traditional processing flow from an input file 12, through a Rip 14, to a printer or imaging device 16.

In preparation for screening via the accelerated method of the present invention, however, the ripping 22 is done to intermediate files of raster data 20, one for each color, that are not screened and, in a preferred embodiment, are stored as unscreened compressed raster data 25 in file storage 24. In other embodiments, where the file storage is substantial and operates at high speeds, it is not necessary to compress the data. Screening is accomplished by a post-ripping step 26, which, now separate, can be handed off to an accelerated GPU-based or other parallel processing type subsystem.

FIG. 2 illustrates this two-step workflow, historically called ROOM in the language of printing, as it permits the page to be Ripped Once and Output Many times. Ripped once refers to the steps of interpreting and rendering the image and saving the results of interpretation and rendering as unscreened raster data, which is often compressed. Output many is the process of screening and sending the screened data to an imaging device 27. This process may have to be done many times during a printing run, because press characteristics often change during a run.

FIG. 3a shows a block diagram of one of the GPU accelerator boards 40 used in the one embodiment of this invention. In this embodiment, the GPU accelerator boards 40 are NVIDIA Tesla K10 accelerator boards that contain 2 GPUs 42, each with 1536 parallel cores 44 and 4 Gigabytes of memory 46. As shown in FIG. 3b, the GPU board 40 plugs into a slot 52 in a host computer 50 that is running in one embodiment under a Windows operating system. Note that other operating systems could be used, and other GPU boards 40, for example other NVIDIA models or GPUs made by made by ATI, could be used. FPGAs or ASICs could also be used.

In addition to creating unscreened raster data, the Rip 22 must also create some auxiliary files. Most of these files would vary according to the needs of different implementers. One file is, however, useful in many embodiments. This file may be categorized as table of contents information. The file specifies where the data for each line of each color starts within the unscreened image file. This table of contents allows quick determination of the location of the data that needs to be sent to each GPU core 44 or other computing device, so the device can screen a line or segment of an input line.

Unscreened data is stored in a network file server 51, and this data is often compressed. In one embodiment two types of compression are used. The higher level compression is an industry standard compression, such as zip or zlib. In one embodiment, the higher level compression is removed by software in the host computer before the software delivers the data, still compressed at a lower level, to a GPU core.

The lower level compression referred to and operated on by GPU cores 44 is run length encoding compression. Horizontal sequences of the same pixel intensity are replaced by a pair of numbers—one denoting the intensity and the other denoting the number of sequential pixels of that intensity. In this way, lengths of unvarying color, for example segments of text or a line that is part of a solid colored object, are efficiently encoded.

There are two fundamental ways of making a computing task function in parallel. Functional parallelism refers to the benefit of having diverse, independent tasks operate simultaneously. On today's computers with their multiple CPU cores, these tasks can operate simultaneously, resulting in reduced overall time.

The other method of achieving parallelism is called data parallelism and is potentially more powerful. In this case, the same algorithm is applied to different input data of the same type. Furthermore, the output data is similarly partitioned and isolated. In one embodiment, each core of a GPU's thousand or more cores has its own dedicated output region in which to put its results.

An additional requirement for efficient parallelism via thousands of GPU cores or other device computing units, is that accesses of common tables and data used simultaneously by each core or unit, as it screens, do not interfere with each other nor slow access by other cores or units. The system and method of one embodiment of the present invention makes use of the special purpose texture hardware 45 built into available GPUs. Texture is a type of memory specifically designed to provide common access to read only data by multiple cores without significant slowdowns. Using texture memory results in having all GPU cores computing simultaneously while not waiting for access to data shared by other cores.

In an embodiment of the present invention using GPUs 42, the GPUs 42 perform in such a manner that screening speeds of fifty to one hundred times, or more, compared to those of non-GPU approaches, are achieved. The actual multiplicative speedup is highly dependent on the details of the GPU kernel coding—the software/hardware coding used by the GPU cores 42. Referring to FIG. 4, eight GPUs 42 are shown relative to how they process the four colors in the image to be reproduced. In this example, each GPU 42 processes half the lines of a single color. Alternatively, it would be possible for each GPU 42 to process one-eighth of the lines of each color of the four colors.

Referring to FIG. 6, the process for screening images utilized by the system of the present invention will now be discussed. A new page or flat comes into the system as a Pdf file (or Postscript or other format). It is pre-flighted, meaning examined for various types of errors, for example missing fonts, and the system checks to determine if the page has already been ripped in step 80. This is accomplished by querying a database 49 that lists input files entered into the system and their current status. If the file has been pre-flighted without errors and has not yet been ripped, the page is ripped in step 82 into to a set of files that are full resolution, possibly compressed, and as yet unscreened. In one embodiment the bit depth of the unscreened tones is 10-bits, that is 1024 gray levels, and there is one file for each color.

The Rip 22 also creates table of contents files containing a beginning of line directory 70 (FIG. 5) pointing to the where in the unscreened data file 72 the data for each line starts. There is one table of contents file for each unscreened file, that is, one table of contents file for each color.

The CPU 54 takes stock of what and how many GPU resources are available in step 84, and together with the specifics of the rendered page, such as size, resolution, number of separations—meaning number of colors, and output bit depth, determines a partition plan in step 88. In the one embodiment there are four GPU boards 40, each containing two GPUs 42. For a four color job, each of the eight GPUs screens half the image of each color. For a six color job, for example, it may be known that four of the colors are relatively simple, such as having many areas in which no ink will be applied. A single GPU might be assigned to each of these four colors, and the remaining four GPUs may be set to process half the data of each of the remaining two colors. Or a system, for cost savings, might have only four or six GPUs, and partitioning would take this into account. A specific example of partitioning follows.

Referring to FIG. 4, an embodiment of the present invention is shown which uses four accelerator boards 40, each with 2 GPUs 42, for a total of 8 available GPU units 42 each containing 1536 cores 44. The rendered page has 4 separations 56, is 30 inches wide by 40 inches high, has a resolution of 1200 dpi, and has a 4 gray-level output. For this screening job a partition plan is generated in which each of the 8 GPUs 42 will be given one task of screening either a top 56a or bottom portion 56b of one of the 4 separations.

At times, because of limited resources—either too few GPUs 42 or not enough GPU memory 46—more GPU tasks may be created than the number of GPUs. For example, assume a job exists, as shown in FIG. 4, in which there are eight GPUs 42, and each GPU 42 handles half of one separation. However, assume that each separation is so large that only one quarter of a separation will fit in GPU memory 46. In this case, sixteen GPU tasks would be created, and the partition plan would not only assign half of each color separation to one GPU 42 but would break the half separation into two GPU tasks in which a single task processes one quarter of one of the four separations.

Referring to FIG. 5, each GPU 42 is pre-loaded. This is accomplished by the host CPU 54 writing data into the GPU 42, the data being all that information the GPU 42 needs for one task. This includes:
1. The unscreened image data in run length form. This data comes from a file that resides in the file server 51. The host computer 50 performs the higher level zip or zlib decompression and delivers data that is unscreened but still run code compressed, to the GPU 42.
2. The Beginning of Line table 70 for the separation or portion of a separation it will process.
3. The screening information it needs. This includes a 2 dimensional threshold matrix 73 that specifies—for a given pixel row, column, and intensity if a dot should be turned on or off, and, if the particular screening type requires it, a jump table 74 containing information on which element of the threshold matrix 73 should be used by the pixel immediately to the right of the current one. Note that threshold matrix 73 screening is well known and commonly practiced in the printing industry.
4. A linearization table 75 used for calibrating the tone data in order to compensate for a nonlinear tone response of the particular imaging device. This table specifies that for each pixel intensity that is input in a run code, what pixel intensity should be used in its place. For example, to produce a linear response on a printing press, intensities of 100, 101, and 102 might have to be replaced by intensities of 95, 96, and 98. This is because ink, when applied to media, tends to spread or shrink. This spread is called dot gain and shrink is called dot loss, and to produce linear intensity, output dot gain or dot loss must be compensated for.
5. A designated region of GPU memory 46 is reserved for the screened output and is initialized to values of all zeros.

Referring back to FIG. 6, multiple threaded programming 90 on the host computer 50 is used to create a separate thread for each GPU task. In a simpler embodiment, the CPU 54 will load up each GPU 42 in turn, with the data it will need, and then launch each GPU 42 in succession rather than all GPUs 42 simultaneously. A faster embodiment uses parallel host processing, via multiple threads, facilitated by the stream mechanism in CUDA, the programming language of the GPUs 42, to have the loading of the GPUs proceed in parallel in steps 90 and 92. The stream mechanism allows GPU 42 operations in different streams, such as the loading of multiple GPUs 42, to occur concurrently.

These dedicated CPU Control threads also include the process of moving the resulting screened data back into main host computer memory 48 in parallel.

Host computer threads are launched simultaneously, and the computer software waits for all threads to finish in step 94.

FIG. 7 shows the details of a GPU Control thread. In step 110, the host computer 50 retrieves all the information needed for the partition that the GPU 42 will compute. In step 112, the host computer 50 prepares the GPU 42 by allocating memory 46 in the GPU 42, copying data from the host computer 50 to the GPU 42, and allocating memory in the host computer 50 to receive results from the GPU 42. The host computer 50 launches the CUDA kernel in step 114, which is the lowest level software in the GPU 42 that controls all GPU activity. The host computer 50 waits for an event that signals when the GPU 42 has completed its assigned work in step 116. The host computer 50 determines in step 118 whether to read GPU results into computer memory 48, and the host computer determines in step 122 whether to send GPU results to an imaging device 27.

Note that if a partition plan creates more GPU tasks than there are GPUs 42, once any GPU thread finishes, such GPU 42 will be given another task from the list of yet unprocessed GPU tasks. This allows the number of GPUs 42 to be scaled down, presumably to save cost, yet still have an arbitrarily large job be screened by the GPUs 42.

The host computer 50 waits for all these GPU task threads to finish. As shown in FIG. 7, the resulting screened data may or may not be read back from the GPUs into host computer memory. For example, a system user may wish to view, on a monitor, the results of the screening and would therefore need the results to be in computer memory. Transmitting the results of the screening to an imaging device is also optional, as there may be times that a user wants to see the results of screening for test purposes but does not wish to print the results.

Note that NVIDIA GPUs have a feature called GPU-Direct which can allow the GPUs 42 themselves to directly send the data to an imaging device without first going through host computer memory. This adds a level of complexity and precludes using the results of screening for purposes such as viewing by a user. Embodiments of the system and method of the present invention may or may not utilize this feature.

If an embodiment uses GPUs, the screening process takes place on the multitude of GPU cores 44 contained in or associated with each GPU subsystem. It is this multitude of cores 44 that provides the speed advantage of the system and method of the present invention, compared to that of traditional CPU cores, and it is the lower cost per core, compared to a CPU core, that provides the cost advantage of the invention.

The kernel program is launched in a multitude of cores, one of which is shown in FIG. 8. Each instance of the kernel program runs in one GPU core 44 and is referred to as a thread.

A thread first determines its unique thread number in step 130, which has been assigned to it by the GPU 42. The thread index is used to determine the output line number for which this thread will be calculating the screening. For example, thread index 1 might be used to screen line 1, thread index 2 for line 2, etc. If the line number is beyond the end of the GPU tasks' allotted lines, for example thread 10,000 when the image to be screened has only 9000 lines, the thread immediately finishes.

In step 132, the line number is used to index into the beginning of line directory, the table of contents of unscreened image data that has been preloaded into each GPU 42. The index provides a pointer to where in the unscreened image data for the line to be screened resides. The line number also determines where in the pre-allocated output memory a thread should put its resulting screened data. For example, the results of the first line would start at output memory location 0. If the output data for each line consists of 10,000 bytes, then the results of the second line would start at output memory location 10,000. The results of the third line would start at output memory location 20,000, etc.

Use of a threshold matrix to perform screening is a well known and widely used technology. In its simplest form, a threshold matrix is square, that is, it has the same number of rows and columns, and a single number resides at each row and column position. For example, a threshold matrix may have 100 rows and 100 columns. The matrix would then consist of 10,000 numbers. When one begins screening, one starts at the first row and first column of the unscreened image data, and one starts at the first row and first column of the threshold matrix. If the intensity of the pixel at the first row and column of the image is greater than the number stored at the first row and column of the threshold matrix, the pixel is turned on, otherwise it is turned off. One proceeds to the second pixel of the first row of the image and screens using the number at the first row and second column of the threshold matrix. Usually an image has more columns than the number of columns in the threshold matrix, so after one screens using the number in the last column of the first row of the threshold matrix, one screens by again using the number in the first column of the first row of the threshold matrix. This process repeats until the whole first row has been screened.

When screening the second row of the image, one uses the second row of the threshold matrix. The third image row uses the third row of threshold matrix, etc. After one uses the last row of numbers in the threshold matrix, one begins by again using the first row of the threshold matrix. One may think of the threshold matrix as being stamped, or repeated, across and down the image.

When GPU 42 is screening the bottom half of an image, rather than the whole of an image, then, for example, the initial location of access would be at threshold matrix column zero, but the correct starting row within the threshold matrix would be a GPU initialization parameter.

Some screening does not use a square threshold matrix. In one type, for example, a diamond shaped matrix is used. The initial position within the matrix must still be provided.

If a diamond or other nonrectangular shaped screening matrix is used, then the screening matrix can not be used column by column and row by row. That is, use of the matrix may require jumping from one number in the matrix to a number that is at a location that is not one row or column away from the currently used number. In this type of screening, in addition to a threshold matrix a rectangular jump table matrix will have to be provided to GPU threads. The jump table is used column by column and row by row and tells the GPU 42 where in the nonrectangular threshold matrix to get threshold data for each pixel. Before screening begins, threshold and jump table matrices are stored in the GPU's texture memories.

Texture memory 45 is memory that is cached on the GPU chip 42. Texture memory also has features that allow it to be accessed quickly for certain types of access patterns, and screening access patterns are well suited to take advantage of these features.

In order to not have each screened output pixel stored in global device memory, which would greatly reduce speed, each thread allocates, for its exclusive use, a set of storage elements.

In some embodiments the storage elements are GPU registers 43. In one embodiment each thread takes 64 integer registers for itself. These are referred to as LocalInts. Since each integer register 43 is 32 bits, this is 2048 bits (256 bytes), or enough in our example for 1024 screened 2-bit gray levels to be stored before having to move these 256 bytes to GPU memory.

Referring to FIG. 8, before starting its main loop and incrementing X to screen pixels across the line, in step 134 the thread code reads in the first input run code to process. The intensity field of the run code—the run code's tone—is stored as the CurrentTone, and a down counter. RemainingLength is initialized with the length field of the run code in step 134.

The threshold matrix is accessed in CUDA texture memory 45, using the X value as the threshold matrix column, and the row value, set when the thread was initialized, is used as the row value. The CurrentThreshold value for this thereby obtained in step 136.

The kernel's main loop then starts. For 1-bit output, if CurrentTone is determined in step 138 to be greater than CurrentThreshold, the output is set to 1 in step 140, otherwise it is set to 0 in step 142. The new output is shifted into the LocalInts. In this manner screening is accomplished and screening results stored.

For the majority of the time, moving on to produce the next pixel involves only register rather than slower memory operations. The RemainingLength is decremented, X is incremented in step 144, and a new CurrentThreshold is fetched from the threshold matrix in texture memory 45. If the threshold mechanism also requires a new NextLocation lookup, which is used with screening types that use a jump table, the jump table is also accessed in texture memory.

This method allows many pixels to be processed with accesses only to registers and texture memory. The following additional checks are made before moving to the next pixel:

If the RemainingLength is determined in step 146 to be zero, the next run code is parsed and new values for CurrentTone and RemainingLength are stored in step 148.

If the local screened output cache, registers 43, is determined to be filled in step 150, then in step 152 the cache contents (the 256 bytes in registers) are copied to the global output memory 76, and the cache is cleared.

The Xposition is incremented in step 154. Xposition points to the pixel position along the line or line segment being screened. If the Xposition is equal to the last position as shown as determined in step 156, then the screening of the line or line segment is done. If Xposition is not equal to the last position, then the next pixel is processed starting at step 136. Note that the last position is not the last pixel to be screened but the pixel after the last one to be screened, such pixel not existing if the GPU thread is screening a whole line or a segment at the end of a line.

In some forms of screening, the creation of a screened line depends on the data in a few—typically one or two—previous screened lines. If the screening of an input line requires data from previously screened output lines, then processing by GPU cores 44 or other computing devices must be started in succession with enough delay between starting the processing of each line to insure that previous line output data will be available.

If an embodiment uses a computing device other than a GPU, similar processes to that described above will be implemented.

The NVIDIA GPU products, programmed with CUDA, have combination hardware/software mechanisms called textures. These are extremely powerful, and when using GPUs, employing the textures effectively is crucial to getting the full performance multiplier of massively parallel programming. Textures are a type of memory that may hold a variety of types of data.

For digital presses, as in all printing, it is necessary to linearize the tone range 0-100%. For example, due to printing effects, putting down a dot pattern that is 50% dark and 50% blank will usually not result in a visual perception of 50%. Dots spread when applied to paper or other media, and this is called dot gain. Sometimes ink does not stick and falls off, and this is called dot loss. Linearization is a straightforward correction that involves a 1-dimensional function, usually implemented as a lookup table in memory. The table is created by printing a test pattern of patches of different dot percentages and measuring, with a densitometer or other optical instrument, the percentage that appears on the printed medium. In some implementations, twenty-five test patches are used, and the density for each of the 1024 input tone values and the linearized output value to use in place of each input tone value is created by interpolation. Every tone level, before screening, gets adjusted through this one dimensional table. The linearization table has been implemented as a 1-D texture of 1024 16-bit integers.

Some printing devices require tone range correction based on location on the printed medium. For example, a digital printing press might, during one printing run, print lighter on the lower right portion of the medium than on other areas. An additional use of texture memory is to hold a two-dimensional table that corrects for this area based tone change. For the area-specific calibration correction, a 2-D texture is used.

While the foregoing invention has been described with respect to its preferred embodiments, various modifications and alterations will become apparent to one skilled in the art. All such modifications and alterations are intended to fall within the scope of the appended claims.

What is claimed is:

1. A method of producing screened raster image data of an image or separation for a digital imaging device comprising the steps of:
writing unscreened raster image data into a computing device that contains a plurality of processors;
dividing said raster image data into data segments;
causing each of said plurality of processors to simultaneously screen a different data segment to provide screened data, each data segment representing a sub-portion of the image or separation;

2. The method of claim 1, wherein said processors are graphical processing units.

3. The method of claim 1, wherein said processors are field programmable gate arrays.

4. The method of claim 1, wherein said processors are application specific integrated circuits.

5. The method of claim 2 wherein each of said graphical processing units includes a plurality of processor cores.

6. The method of claim 5 wherein said graphical processing units include texture memory that enable said graphical processing units to have common access to read only data by multiple processor cores.

7. The method of claim 6 further comprising the step of utilizing a threshold matrix for organizing data related to said digital image.

8. The method of claim 6 further comprising the step of utilizing a jump table for organizing data related to said digital image.

9. A method of claim 6 further comprising the step of providing a lookup table to serve as a tone linearization function for organizing data related to said digital image.

10. The method of claim 1, wherein said unscreened raster image data is the ripped data result of a Rip operating on a Postscript or a Pdf page.

11. The method of claim 1 whereby said unscreened raster image data is in a compressed format.

12. The method of claim 1 wherein said step of writing unscreened raster image data into a computing device comprises the step of transferring unscreened raster image data to the computing device along with a table of Beginning-of-Line data that specifies the offset into said unscreened raster image data where each line begins.

13. The method of claim 1 wherein pinned or non-pageable memory is used to enable readback of said screened data to a CPU of said computing device at a hardware capable speed.

14. The method of claim 1 wherein said screened data is transferred directly from the computing device to a digital printing press.

15. The method of claim 1 wherein said screened data is transferred directly from the computing device to a platesetter.

16. The method of claim 1 wherein said screened data is transferred directly from the computing device to a printing device.

17. A system for producing screened raster image data for a digital imaging device comprising:
a central processing unit;
a plurality of processors capable of processing unscreened raster image data, each of said processors including a plurality of processing cores;
wherein said central processing unit divides said unscreened raster image data into data segments with different data segments being screened simultaneously by said processing cores.

18. The system of claim 17, wherein said processors are graphical processing units.

19. The system of claim 17, wherein said processors are field programmable gate arrays.

20. The system of claim 17, wherein said processors are application specific integrated circuits.

21. The system of claim 5 wherein said graphical processing units include texture memory that enable said graphical processing units to have common access to read only data by said multiple processor cores of each graphical processing unit.
